(19) United States
(12) Patent Application Publication
(10) Pub. No.: US 2001/0010437 A1
(43) Pub. Date: Aug. 2, 2001

(54) Electrical machine, in particular three phase generator

(76) Inventors: Martin-Peter Bolz, Buehl (DE); Robert Schenk, Vaihingen/Enz (DE); Ulrich Kappenstein, Knittlingen (DE)

Correspondence Address: STRIKER, STRIKER & STENBY, 103 East Neck Road, Huntington, NY, 11743, US

(21) Appl. No.: 09/772,370

(22) Filed: Jan. 30, 2001

(30) Foreign Application Priority Data
Feb. 1, 2000 (DE) 1 00 04 239.2

(51) Int. Cl. H02K 49/00; H02K 7/10

(52) U.S. Cl. 310/75 R; 310/103

(57) ABSTRACT

An electrical machine, such as a three phase current generator and a starter generator has a stator housing, a shaft supported in the stator housing and carrying an impeller, a stator plate pack mounted on the stator housing and surrounding the impeller, a stator and a rotor chamber and a space which is separated from the chambers in a cooling medium tight manner, a cooling medium pump which is driven by a shaft for heating a cooling medium, the cooling medium pump being arranged in the space, a magnetic coupling through which the cooling medium pump is drivable and which transmits a driving moment from the shaft to the cooling medium pump, the magnetic coupling having a driving part and a driven part which are separated from one another by a magnetically inactive and electrically poorly conductive wall.

### BACKGROUND OF THE INVENTION

The present invention relates to an electrical machine, in particular a three phase generator or a starter generator.

The German document DE-OS 34 17 307 discloses a three phase generator and a cooling medium pump driven through a common shaft. The drive element is driven through a belt pulley, which is conventional for generators. The cooling medium pump is arranged near the impeller of the generator part. The cooling medium is supplied in the cooling medium pump by the shaft rotation. Simultaneously, a part of the heat produced in the generator is transported away by the cooling medium movement.

A disadvantage of this known arrangement is that the pump which is integrated in the housing of the generator has a big volume, and for example in the case of failure must be exchanged together with the generator and then repaired in relatively expensive way. With the rigid connection between the impeller and the cooling medium pump, there is a danger of the cavitation during pumping and thereby a danger of damage to the cooling medium pump.

### SUMMARY OF THE INVENTION

Accordingly, it is an object of present invention to provide an electrical machine, in particular a three phase generator or a starter generator which avoids the disadvantages of the prior art.

In keeping with these objects and with others which will become apparent hereinafter, one feature of present invention resides, briefly stated, in an electrical machine of this type in which the cooling medium pump is drivable through a magnetic coupling which transmits a drive moment from the shaft to the cooling medium pump, and the magnetic coupling has a driving part and a driven part which are separated by a magnetically inactive and electrically poorly conductive wall.

When the electrical machine is designed in accordance with the present invention, it has the advantage that the cooling medium pump is mounted separately on the machine. The cooling medium pump is moreover relatively compact and thereby light. The cooling medium pump is easily accessible and thereby easily exchangeable, which is especially advantageous for repairs.

The driven part of the magnetic coupling can be formed in accordance with the present invention as an exciter. This provides for the advantage that the active element of the magnetic coupling is easily accessible. This is especially advantageous in connection with the maintenance of the active part, which is more expensive than the inactive part.

A particularly simple design of the driven part is provided when it is formed as a magnetic disk with permanent magnets. A further advantageous embodiment of the magnetic coupling is provided when it is formed as a synchronous drive. The torque action in the magnetic coupling is thereby jerk free and the forces in the magnetic coupling are easily contollable. Thereby the danger of the cavitation in the cooling medium pump is substantially reduced.

An especially favorable design of the magnetic coupling is provided when the driving part is an electrically highly conductive disk and the driven part is the exciter. In this combination the expensive and thereby eventually sensitive component is easy to replace. When the exciter of the magnetic coupling is formed as an electromagnet it is possible by controlling or regulation of the current of the coil of the electromagnet to control or regulate the efficiency and thereby the transmitted moment and the pump efficiency as needed.

A part of the cooling medium circulation can be provided on the periphery of the stator, in particular on its stator housing and between an outer housing, so that preferably the cooling effect on stator is possible. A particularly favorable design of a pump support is provided when the bearing point for the pump shaft is located in a central cooling medium inlet which is coaxial to the shaft. A second bearing point can be provided for the pump wheel, so that it is advantageous when the second bearing point is located in a not self-supporting part, which is independent from a bearing of the shaft of the impeller. On the other hand, there is a possibility to provide the second bearing point in the housing bottom of the electrical machine and thereby to save components.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic partial view of a starter generator in accordance with the present invention;

FIGS. 2-5 are views showing different embodiments of a magnetic coupling of the inventive starter generator;

FIG. 6 is a view showing a section of an electrical machine with a cooling medium pump in a rear bearing region in accordance with another embodiment of the invention.

### DESCRIPTION OF THE PREFERRED EMBODIMENTS

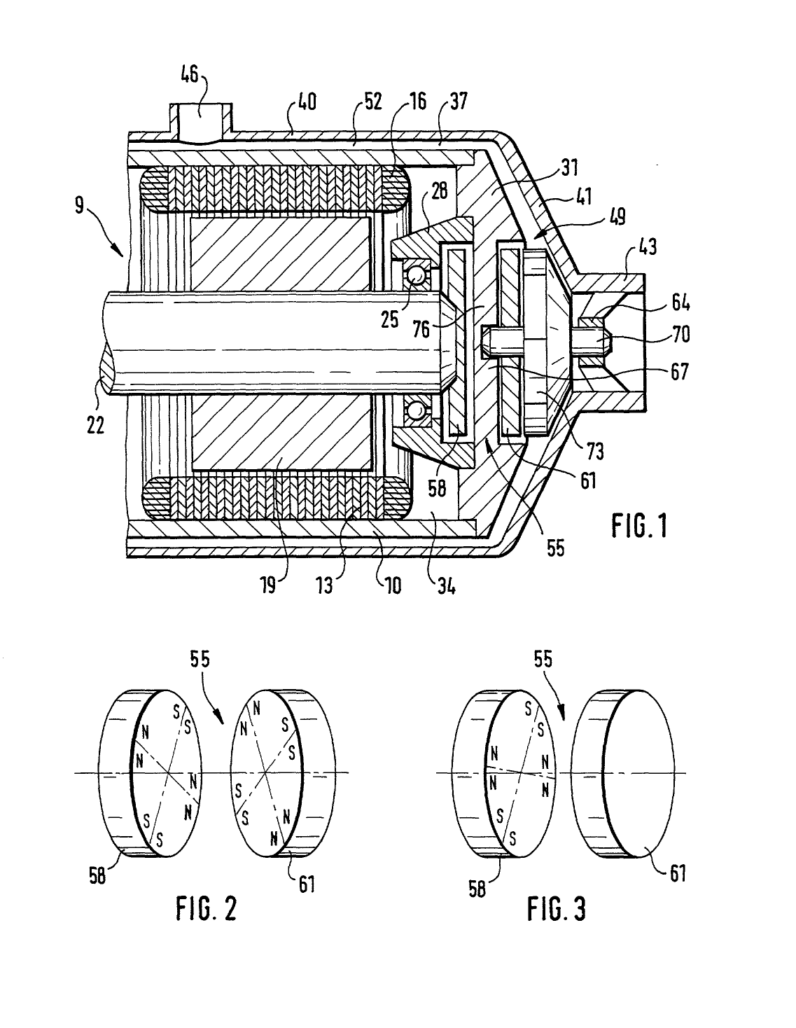

FIG. 1 shows a first embodiment of an electrical machine 9. A stator plate pack 13 with a stator winding 16 are arranged in a stator housing 10. A rotatable impeller 19 is arranged inside the stator plate pack 13 and is driven by a shaft 22. The shaft is drivable through a not shown belt pulley. The shaft 22 is rotatably supported in a bearing insert 28 by a bearing 25. The bearing insert 28 is arranged fixedly in a housing bottom 31. The housing bottom 31 closes the stator housing 10 and separates a stator and rotor chamber 34 from a cooling medium chamber 37. The housing bottom 31 and the stator housing 10 are surrounded by a cup-shaped outer housing 40. The outer housing 40 has a cooling medium inlet 43 which is formed in a continuously funnel-shaped expanding bottom 41. An outlet 46 is arranged in a region of the outer housing 40 which faces away from the cooling medium inlet 43.

A cooling medium pump 49 is arranged in the funnel-shaped expanding bottom 41 of the outer housing 40. The cooling medium pump 49 feeds the cooling medium through the cooling medium inlet 43, conventionally water or a water mixture from the cooling system of an internal combustion engine into the funnel-shaped region of the outer housing 40 and thereby in a space between the housing bottom 41 and the outer housing 40. After the cooling medium reaches the outer region of the stator housing 10, the cooling medium is supplied to the cooling passages 52 in the region which surrounds the stator housing 10, for example meanderingly. The cooling medium leaves the electrical machine 9 through the outlet 46 and is supplied back through a hose into the cooling system of the internal combustion engine.

The cooling medium pump 49 is drivable by the shaft 22 and magnetic coupling 55. The magnetic coupling 55 is composed of a shaft-side driving part 58 and a pump-side driven part 61. The cooling medium pump 59 is supported at an inlet side in a first bearing point 64 held on braces, and at a coupling side is supported in the second bearing point 67. During the operation the shaft 22 drives through the magnetic coupling 55 a pump gear 73 arranged on a pump shaft 70.

FIG. 2 shows a first embodiment of the magnetic coupling 55. For better visibility, both coupling halves are shown as spread from one another. Both the driving part 58 and the driven part 61 are formed as magnetic disks and have the same diameters. The magnetic discs are formed as permanent magnets with segment-shaped alternating north and south poles. For driving of the pump gear 73, the south pole is located opposite to the driving part 68 and the north pole is located opposite to the driven part 61 and vice versa. The housing bottom 31 separates both coupling halves with a wall region 76. The wall region 76 must be composed of a magnetically neutral and electrically poorly conductive material. For this purpose in particular fiber-reinforce synthetic plastics, polyphenylenesulfide (PPS) and the high grade steel X5CrNi 18 9 which is non magnetic and has a high electrical resistance are suitable.

FIG. 3 shows a second embodiment of the magnetic coupling 55 and a first design as an asynchronous drive. The driving part 58 is here formed as shown in FIG. 2. In contrast to the embodiment of FIG. 2, the driven part 61 however has a cylindrical disk. In the second embodiment of the magnetic coupling 55 the driving part 58 is offset relative to the driven part 61 in a relative turning, whereby electrical currents are induced in the driven part 61. They are oriented so that the driven part 61 is taken along by the electromagnetic alternating actions and thereby the pump gear 17 is driven.

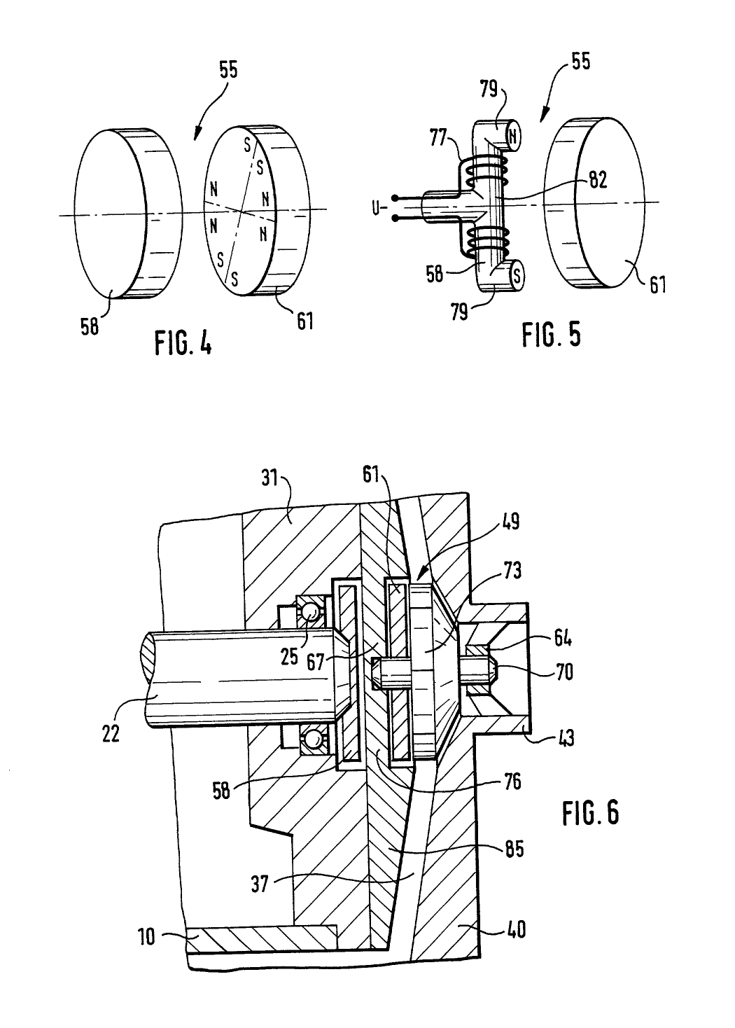

In the third embodiment of the magnetic coupling of FIG. 4 the arrangement is exactly opposite to the arrangement of FIG. 3. In this embodiment the driving part 58 formed as a driven part 61 in FIG. 3 is rotatable relative to the driven part 61 formed as the driving part 58 of FIG. 3. Thereby in this driving part 58 electrical currents are induced which again produce alternating action to the permanent magnetic field of the driving disk 61 and thereby take along the driving disk 61.

FIG. 5 shows a fourth embodiment for the magnetic coupling. The magnetic coupling 55 has here a driving part 58 which is electromagnetically excitable by a coil 77 and forms an electromagnet 78. The driving part 58 is U-shaped. The driving part 58 has two legs 79 which are oriented in the axial direction and are connected with one another by a leg connector 82. The leg connector 82 is excitable electromagnetically by the coil 77. The driven part 61 as in the embodiment of FIG. 3 is formed however as a cylindrical disk which is drivable as a synchronous motor.

The current of the coil of the electromagnet 78 can be supplied for example as an excitation current for an excitation coil of a claw pole generator through a sliding ring and thereby sliding contacts. When it is desired to provide a regulating or controllable pump output, the current of the coil 77 can be changed by a regulator or a control device.

In the embodiment of FIG. 6, a different design for the bearing of the cooling medium pump 49 is shown. While in the embodiment of FIG. 1, the pump shaft 68 on the one hand is supported in a first bearing point 64 in the cooling medium inlet 43 and the second bearing point 67 in the housing bottom 31, or in particular its wall region 76, the second bearing point cooling medium pump 49 is no longer supported in a separate wall part 85. The wall part 85 in this example must receive the forces of the cooling medium pump 49 and is mounted on the housing bottom 31. Furthermore, the shaft 22 is no longer directly connected through the bearing insert 28 with the housing bottom 31, but instead is directly supported in the housing 31. Also, here the wall region 76 is located between the both parts of the magnetic coupling and must be composed of a magnetically inactive and electrically poorly conductive material. Thereby the wall part 85 is releasable independently from the shaft 22, and as a result in the event of disturbance the cooling medium pump 49 can be exchanged separately from the electrical machine 9 and repaired.

In order to avoid additional losses in the magnetic coupling 55, moreover both the bearing insert 28 and the housing bottom 21 can be composed both of non magnetic and also poorly electrically conductive material.

It will be understood that each of the elements described above, or two or more together, may also find a useful application in other types of constructions differing from the types described above.

While the invention has been illustrated and described as embodied in electrical machine, in particular three phase generator, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by letters patent is set forth in the appended claims:

1. An electrical machine, such as a three phase current generator and a starter generator, comprising a stator housing; a shaft supported in said stator housing and carrying an impeller; a stator plate pack mounted on said stator housing and surrounding said impeller; means forming a stator and a rotor chamber and a space which is separated from said chambers in a cooling medium tight manner; a cooling medium pump which is driven by a shaft for heating a cooling medium, said cooling medium pump being arranged in said space; a magnetic coupling through which said cooling medium pump is drivable and which transmits a driving moment from said shaft to said cooling medium pump, said magnetic coupling having a driving part and a driven part which are separated from one another by a magnetically inactive and electrically poorly conductive wall.

2. An electrical machine as defined in claim 1, wherein said driven part is formed as a magnetic disk with permanent magnets.

3. An electrical machine as defined in claim 1, wherein said magnetic coupling is formed as an asynchronous drive, one of said parts being formed as an exciter while the other of said parts is formed as an electrically highly conductive disk.

4. An electrical machine as defined in claim 3, wherein said driving part is formed as said exciter and said driven part is formed as said electrically highly conductive disk.

5. An electrical machine as defined in claim 3, wherein said driving part is formed as an electrically highly conductive disk, while said driven part is formed as an exciter.

6. An electrical machine as defined in claim 3, wherein said exciter is formed as an element selected from the group consisting of an electromagnet element and a permanently magnetic element.

7. An electrical machine as defined in claim 6, wherein said electromagnet has a coil with a current which is controllable or regulatable.

8. An electrical machine as defined in claim 1; and further comprising an outer housing which surrounds said stator housing so that a part of a cooling medium circulation is provided between said stator housing and said outer housing.

9. An electrical machine as defined in claim 8, wherein said outer housing has a cooling medium inlet which is central to said shaft and in which a first bearing point for a pump shaft is located.

10. An electrical machine as defined in claim 9; and further comprising means forming a stator and rotor chamber side wall region which separates said driving part and in which a second bearing point for said pump shaft is located.

11. An electrical machine as defined in claim 10, wherein said wall region is a part of a housing bottom which closes said stator and rotor chamber and receives a bearing.

12. An electrical machine as defined in claim 10, wherein said wall region is a part of a wall part which is releasable independently of a bearing of said shaft.
